(19) United States
(12) Patent Application Publication
(10) Pub. No.: US 2026/0025043 A1
(43) Pub. Date: Jan. 22, 2026

(54) POWER GENERATION SYSTEM FOR TRANSPORTATION

(71) Applicant: Sangsin Brake Co., Ltd., Daegu-si (KR)

(72) Inventors: Dong Jin HA, Daegu-si (KR); Jung Gyu HWANG, Daegu-si (KR); Jae Hoon KIM, Daegu-si (KR); Jin Su JANG, Daegu-si (KR); Cheol Wan PARK, Daegu-si (KR)

(73) Assignee: Sangsin Brake Co., Ltd., Daegu-si (KR)

(21) Appl. No.: 18/908,999

(22) Filed: Oct. 8, 2024

(30) Foreign Application Priority Data
Jul. 22, 2024 (KR) 10-2024-0096658

(51) Int. Cl. H02K 7/18; B60T 1/06; G01P 3/44; H02K 7/102; H02K 21/22

(52) U.S. Cl. CPC H02K 7/1846; H02K 7/102; H02K 21/22; B60T 1/065; G01P 3/44

(57) ABSTRACT

The present invention relates to a power generation system for a transportation vehicle. The power generation system includes an axle, a brake disc having a space in a center, a rotor installed on an inner surface of the space to face the axle and having a plurality of permanent magnets, a stator installed on an outer surface of the axle to face the rotor and having a coil, and a tone wheel installed on a side of the brake disc. The present invention not only greatly increases the space utilization of a transportation vehicle, but also eliminates the need for separate wiring work to supply power from another vehicle.

### FIELD OF THE INVENTION

The present invention relates to a power generation system for transportation, and more particularly, to a power generation system installed in a brake disc device for a vehicle.

### BACKGROUND ART

Among transportation vehicles, trailers are vehicles that are connected to a tractor (towing vehicle) to carry cargo or people without power. They are largely divided into commercial trailers and camping trailers. Commercial trailers need power (electric energy) for indoor lights, tailgate, refrigerators, etc., and camping trailers need power to operate home appliances such as indoor and outdoor lights, TVs, and refrigerators.

Currently, the power for the trailer is either from the tractor battery or generated by a diesel generator installed separately on the trailer.

On the other hand, if the power of the tractor battery is used, some modifications to the tractor are required in the process of installing the power supply line. If a diesel generator installed separately on the trailer is used, maintenance such as frequent diesel fuel injection and lubricant injection are required, and there are various restrictions on the installation and operation of the diesel generator due to the limited internal space of the trailer. In addition, there is the problem of noise and harmful gases being generated while the diesel generator is in operation.

### DETAILED DESCRIPTION OF THE INVENTION

### Technical Problem

Accordingly, an objective of the present invention is to provide a power generation system that self-generates electricity required by a transportation vehicle, such as a trailer.

### Technical Solution

One aspect of the present invention to achieve the foregoing objectives is a power generation system for transportation, the power generation system comprising: an axle; a brake disc having a space in a center; a rotor installed on an inner surface of the space to face the axle and having a plurality of permanent magnets; a stator installed on an outer surface of the axle to face the rotor and having a coil; and a tone wheel installed on a side of the brake disc.

Preferably, the power generation system further comprises a magnetic flux controller for suppressing magnetic flux of the permanent magnets from being transmitted to the tone wheel. The magnetic flux controller is a groove formed in the brake disc between the permanent magnets and the tone wheel.

Preferably, the tone wheel is formed integrally with the brake disc.

### Technical Effects

The present invention adopts a self-generation method in which a generator is installed in a space provided in a brake disc device of a transportation vehicle such as a trailer to directly supply the necessary electric energy, thereby eliminating power-related problems of conventional trailers.

In addition, the present invention not only greatly increases the space utilization of the transportation vehicle, but also eliminates the need for separate wiring work to supply power from other vehicles such as tractors. Furthermore, since the present invention does not require a diesel generator, there is no noise or harmful gas generated by the installation and operation of a diesel generator, and maintenance costs are greatly reduced.

### BRIEF DESCRIPTION OF THE DRAWINGS

FIG. 1 is a cross-sectional view of a power generation system according to one embodiment of the present invention.

FIG. 2 is a detailed cross-sectional view parallel to the longitudinal direction of the axle of the power generation system shown in FIG. 1.

FIG. 3 is a cross-sectional view perpendicular to the longitudinal direction of the axle of the power generation system shown in FIG. 2.

FIG. 4 is a block diagram of an electric circuit according to an embodiment of the present invention.

FIG. 5 is a circuit diagram of the generator and the rectifier shown in FIG. 4.

FIG. 6 is a graph illustrating the power output of the power generation system shown in FIG. 2.

FIG. 7 is a graph illustrating the phase voltage of the power generation system shown in FIG. 2.

FIG. 8 is a graph illustrating the phase current of the power generation system shown in FIG. 2.

FIG. 9 is a cross-sectional view parallel to the longitudinal direction of the axle of the power generation system according to another embodiment of the present invention.

FIG. 10 is an enlarged view of part A shown in FIG. 9.

FIG. 11 is a schematic diagram of a part of the power generation system shown in FIG. 9.

FIG. 12 is a network diagram illustrating system monitoring in an embodiment of the present invention.

### BEST MODE FOR ACCOMPLISHING THE INVENTION

Hereinafter, embodiments of the present invention will be described in detail with reference to the accompanying drawings. In describing the embodiments of the present invention, identical elements are described with identical reference numerals as much as possible in the drawings. Specific descriptions of the configuration or function of related known technologies may be omitted so as not to obscure the gist of the present invention. In addition, the matters expressed in the accompanying drawings are diagrammatically illustrated for the purpose of easily explaining the embodiments of the present invention and may differ from the form actually implemented.

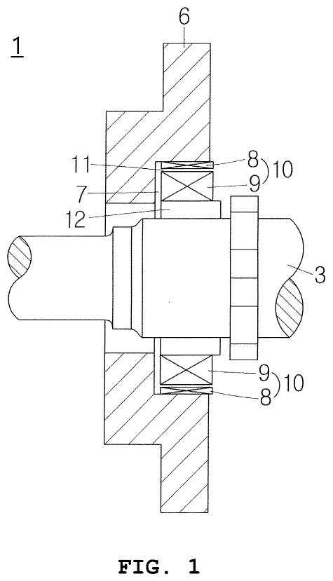

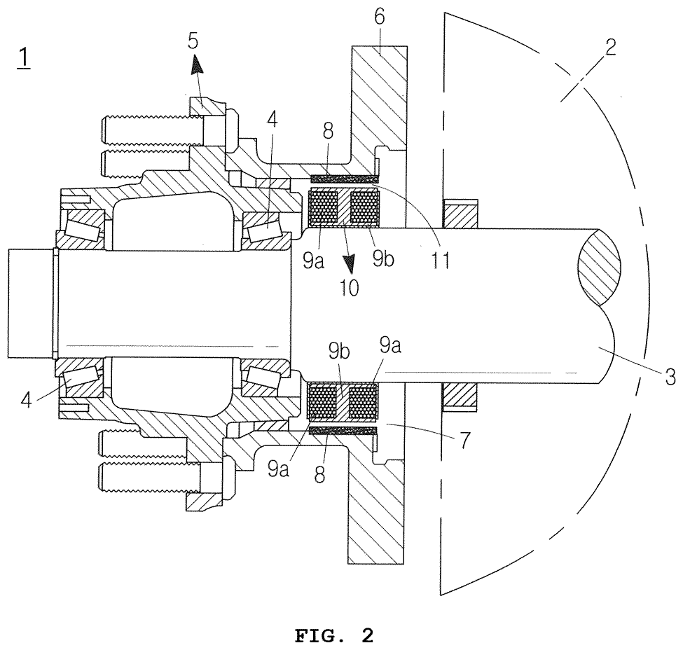

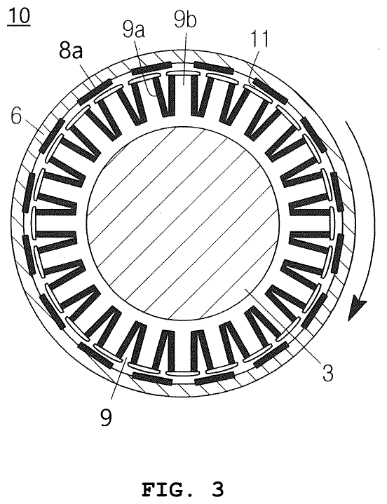

FIG. 1 is a cross-sectional view of a power generation system 1 according to an embodiment of the present invention. As illustrated, the power generation system 1 includes an axle 3, a brake disc 6, and a generator 10. FIG. 2 is a detailed cross-sectional view parallel to the longitudinal direction of the axle 3 of the power generation system 1 illustrated in FIG. 1, and FIG. 3 is a cross-sectional view perpendicular to the longitudinal direction of the axle 3 of the power generation system 1 illustrated in FIG. 2.

The axle 3 is fixed to a chassis 2 of a vehicle (e.g., a trailer). A wheel hub 5, together with the brake disk 6, is installed on the outer surface of the axle 3 via a plurality of bearings 4 and rotates passively. A space 7 is formed in the center of the brake disc 6. The space 7 may be recessed into one side surface of the brake disk 6.

The generator 10 has a rotor 8 and a stator 9. The rotor 8 is installed on the inner surface of the space 7 so as to face the axle 3 and has a plurality of permanent magnets 8a. The rotor 8 may be in the form of a ring in which a plurality of permanent magnets 8a are arranged at equal intervals and are closely fixed to the inner surface of the space 7 of the brake disc 6. Since the permanent magnets 8a are closely fixed to the inner surface of the space 7 of the brake disc 6, they rotate along the brake disc 6 (or wheel). The stator 9 is fixed to the outer surface of the axle 3 opposing the rotor 8. The stator 9 is configured by winding stator coils 9a around a yoke 9b. The yoke 9b is configured by laminating a plurality of thin iron plates, and three stator coils 9a are wound around the yoke 9b. One phase of alternating current is induced in each of the three stator coils 9a, so that three phases of alternating current are induced overall. The stator coils 9a may be a Y-connected structure having a high line-to-line voltage. The stator coils 9a may be wired into the interior of a vehicle (e.g., a trailer) through a hole formed in the longitudinal direction of the axle 3. A predetermined gap 11 is formed between the rotor 8 and the stator 9, so that the rotor 8 and the stator 9 are close to each other but do not touch each other.

A rotor 8 composed of a plurality of permanent magnets 8a arranged in a ring shape is installed in the space 7 of a brake disc 6 and generates a rotating magnetic field when it rotates. When the rotating magnetic field generated by the rotor 8 is linked to the stator 9 composed of the stator coils 9a and the yoke 9b, electric power is generated in the stator 9.

The generator 10 may be a permanent magnet synchronous generator. In addition, the generator 10 may be a brushless synchronous generator. The permanent magnet synchronous generator (PMSG) has an efficiency that is about 90% higher than that of a general induction generator by using permanent magnets, and has the advantage of being compact and lightweight, and being able to operate at low speeds because it does not have gears.

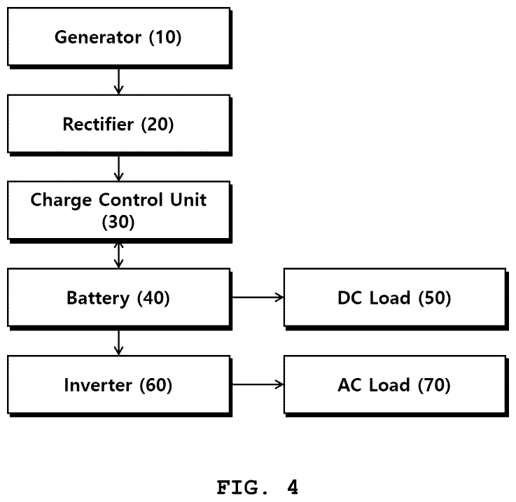

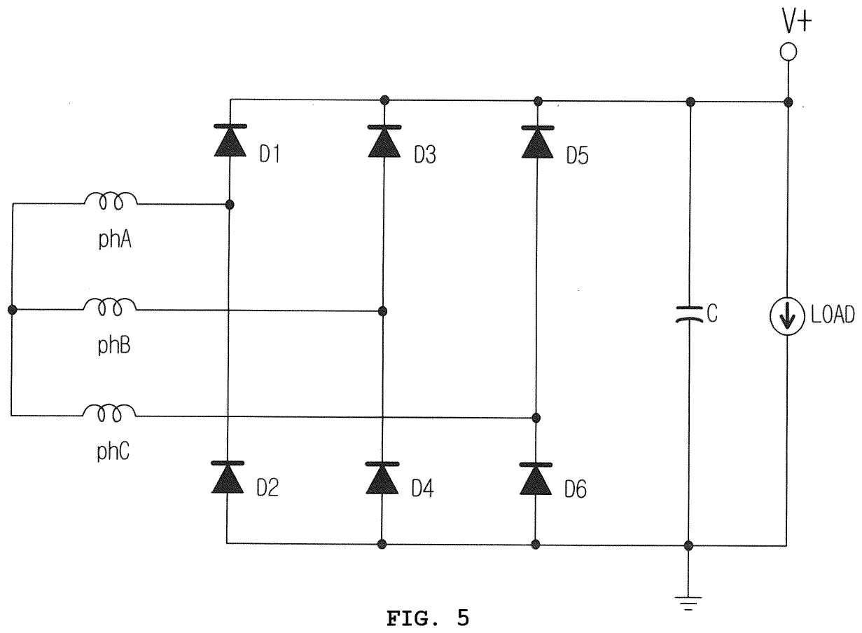

FIG. 4 is a block diagram of an electric circuit according to an embodiment of the present invention, and FIG. 5 is a circuit diagram of the generator 10 and the rectifier 20 shown in FIG. 4.

The three-phase AC power output from the generator 10 is converted into DC power by the rectifier 20. As shown in FIG. 5, the rectifier 20 includes diodes D1, D2, D3, D4, D5, D6 and a smoothing capacitor C. The three-phase AC power output from the three-phase stator coils (phA, phB, phC) of the generator 10 is rectified by a plurality of full-wave diodes D1, D2, D3, D4, D5, D6 and then smoothed by the smoothing capacitor C, thereby outputting a DC voltage V+ to both terminals of the capacitor C to drive a DC load LOAD.

The DC power can be charged to the battery 40 by the charge control unit 30 and then supplied to the DC load 50. The power of the battery 40 can be converted into AC power of 50 to 60 Hz by the inverter 60 and then supplied to the AC load 70.

The charge control unit 30 may include a constant voltage unit and/or a constant current unit. The constant voltage unit and/or the constant current unit stabilizes the DC power output from the rectifier 20. The inverter 60 may output three-phase AC power and single-phase AC power simultaneously or alternatively. The outputs of the battery 40 and the inverter 60 are each provided with terminals or outlets for connecting two or more loads, such that two or more AC loads 50 and DC loads 50 may be connected.

The phase voltage, phase current, and output power of the generator 10 are determined by the rotational speed of the brake disk 6 (or the rotational speed of the permanent magnets 8a), the magnetic force intensity of the permanent magnets 8a, and the number of turns of the stator coils 9a.

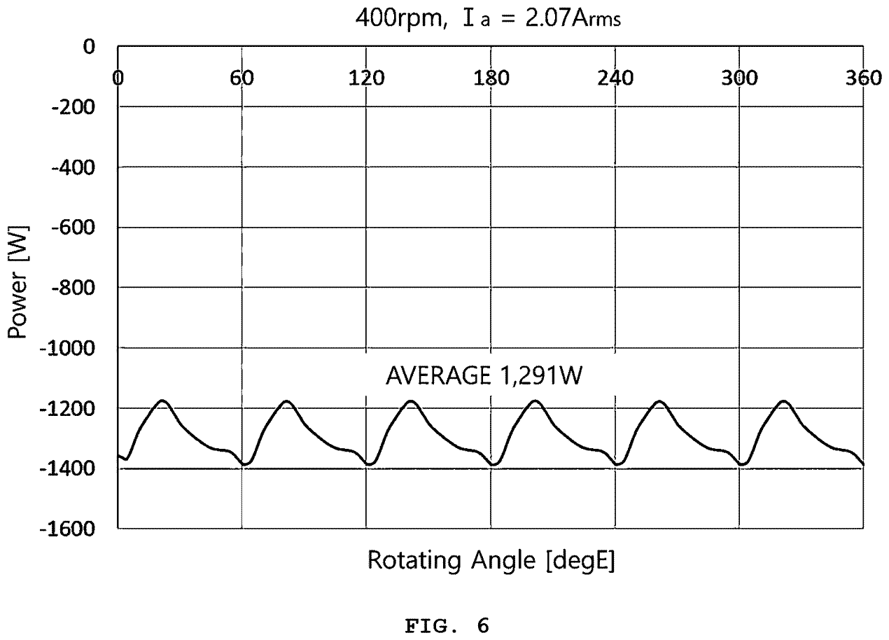

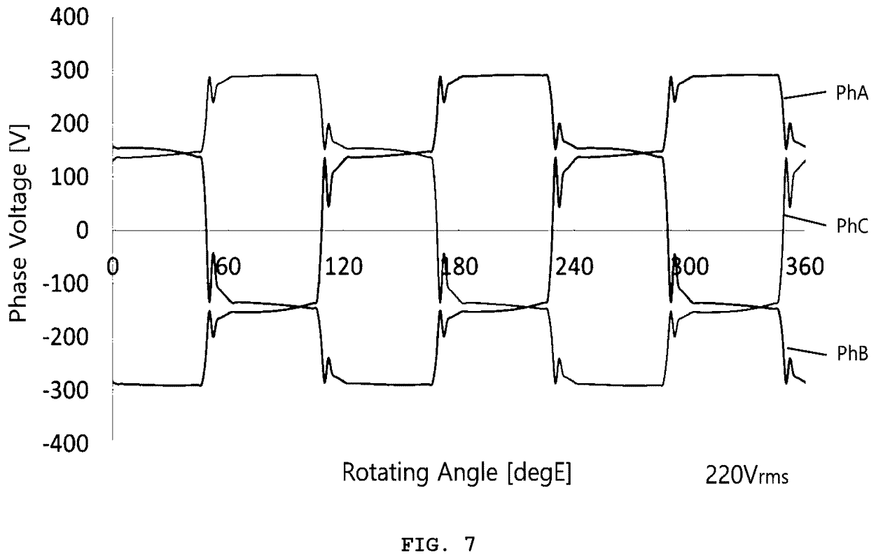

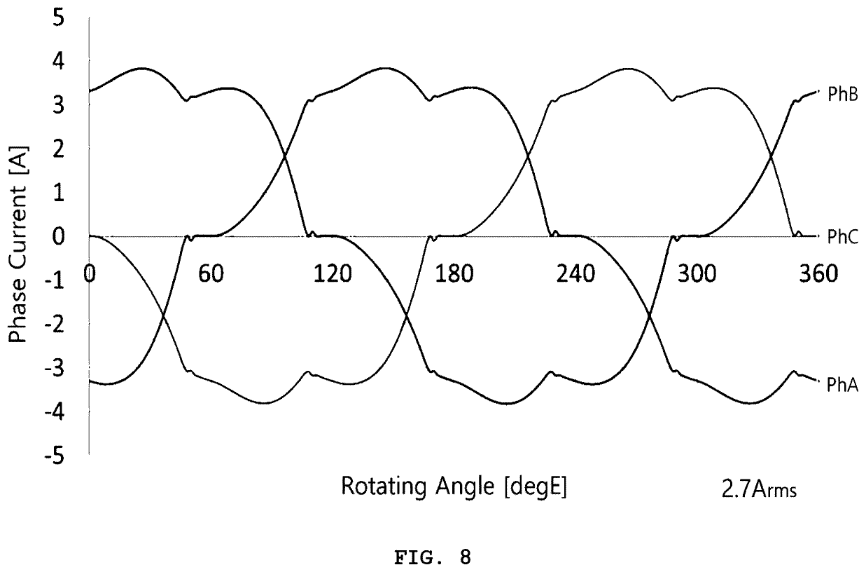

FIG. 6 is a graph illustrating the output power of the power generation system 1 shown in FIG. 2. It shows that an average power of 1,291 W was obtained when the rotation speed of the brake disc 6 was 400 rpm. FIG. 7 shows that a phase voltage of 220 V was obtained from the power generation system 1. FIG. 8 shows that a phase current of 2.7 A was obtained from the power generation system 1.

For example, when a trailer is towed by a tractor, the wheel (or wheel hub 5) rotates, and the brake disc 6 fixed to the wheel hub 5 rotates in conjunction. As the brake disc 6 rotates, the permanent magnets 8a installed in the space 7 rotates to generate a rotating magnetic field, which in turn generates an induced voltage in the stator coils 9a. The AC power generated from the generator 10 is converted into DC power by the rectifier 20 and then charged to the battery 40 by the charge control unit 30. The DC power charged to the battery 40 is supplied to multiple DC loads 50 of the trailer, or is converted into AC power by the inverter 60 and supplied to multiple AC loads 70.

For example, it is desirable for the generator 19 to be installed in each central space 7 of multiple brake disks 6 installed in the trailer to generate sufficient power.

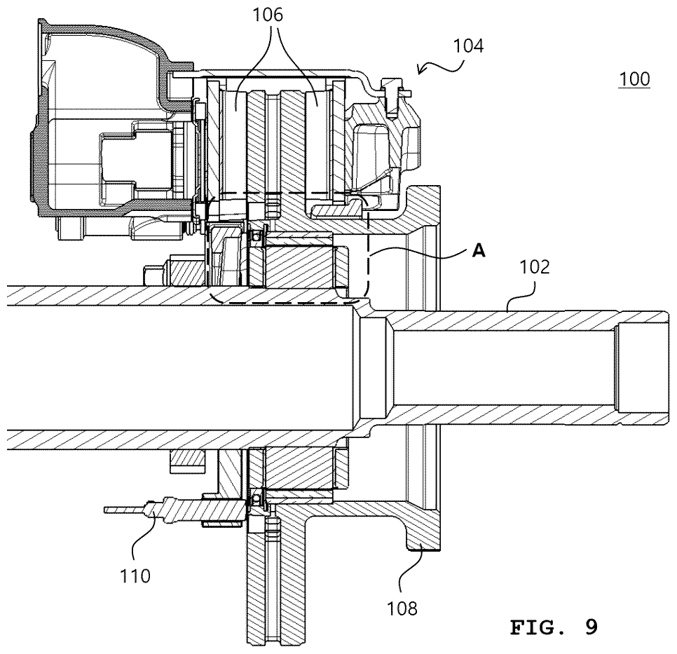

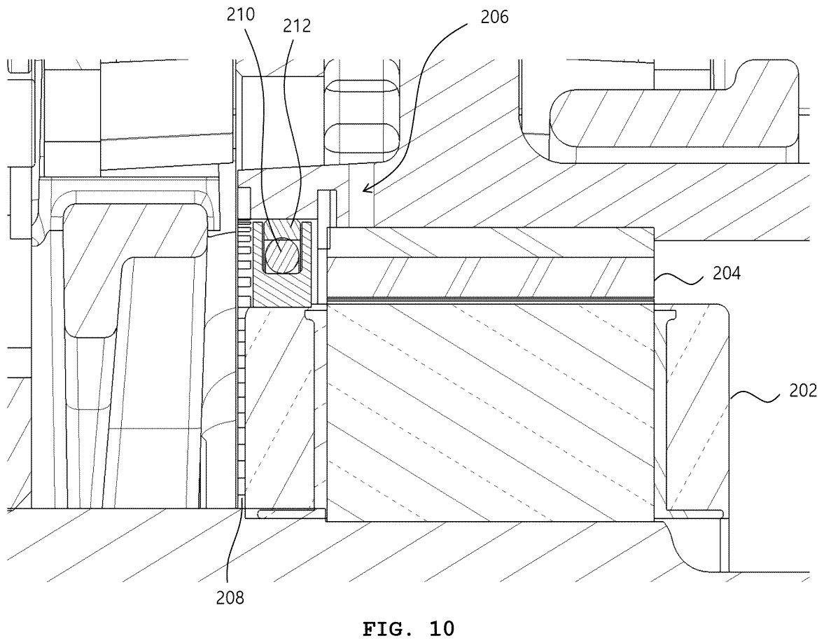

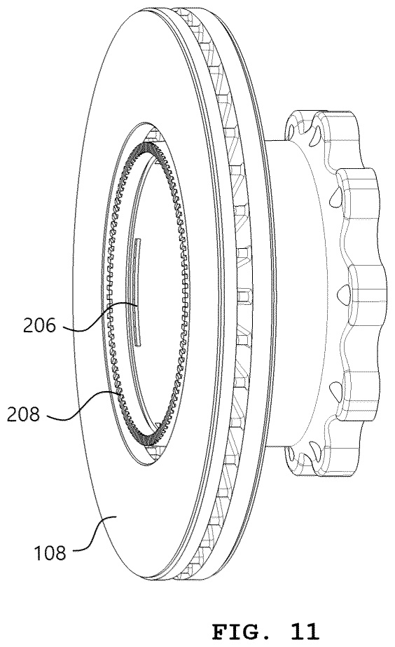

FIG. 9 is a cross-sectional view parallel to the longitudinal direction L of the axle 102 of the power generation system 100 according to another embodiment of the present invention. FIG. 10 is an enlarged view of portion A shown in FIG. 9, and FIG. 11 is a schematic diagram of a part of the power generation system 100 shown in FIG. 9. As shown in FIG. 9, the power generation system 100 has an axle 102, a brake disc 104, a generator 105, and a tone wheel 110. The generator 105 has a rotor 108 and a stator 106.

The brake disc 104 has a space 109 in the center. The rotor 108 is installed on the inner surface of the space 109 so as to face the axle 102 and has a plurality of permanent magnets. The stator 106 is installed on the outer surface of the axle 102 so as to face the rotor 108 and has coils. A tone wheel 110 is installed on one side of the brake disc 104. The tone wheel 110 has exciter teeth and is installed so that the front face faces the longitudinal direction L of the axle 102. The tone wheel 110 may be formed integrally with the brake disc 104. The power generation system 100 further has a wheel speed sensor 112 so as to face the tone wheel 110. The wheel speed sensor 112 senses the rotational speed of the wheel by detecting changes in the magnetic field as the wheel rotates.

The power generation system 100 further includes a magnetic flux controller for suppressing the magnetic flux of the permanent magnets constituting the rotor 108 from being transmitted to the tone wheel 110. The power generation system 100 has an advantage in that it can be configured very compactly since the rotor 108 and the wheel speed sensor 112 are positioned inside the brake device or very close to the brake device. However, there is a concern that the magnetic flux of the permanent magnets constituting the rotor 108 may affect the wheel speed sensor 112 via the tone wheel 110, causing the wheel speed sensor 112 to malfunction. The magnetic flux controller suppresses the magnetic flux of the permanent magnets from being transmitted to the tone wheel 110, thereby allowing the wheel speed sensor 112 to operate normally.

In this embodiment, the magnetic flux controller is implemented as a groove formed in the brake disc 104 between the rotor 108 (or permanent magnets) and the tone wheel 110. Meanwhile, an electromagnetic shield can be used as magnetic flux controller. The electromagnetic shield can be made of a magnetic material (iron, nickel, cobalt, etc.) or a conductive material (copper, aluminum, etc.) that can suppress the magnetic flux of the permanent magnets from being transmitted to the tone wheel 110.

When pneumatic, hydraulic, or the like is applied, the caliper assembly 114 presses the brake pads 116 against the brake disc 104 to generate braking force. In the process of generating braking force, the brake pads 116 are worn. Since the brake pads 116 include a metal component attracted to the permanent magnets, the pad dust generated by the wear of the brake pad 116 is attracted to the permanent magnets of the rotor 108. As a result, a small gap 203 between the rotor 108 and the stator 106 may be filled with pad dust. If the gap 203 is filled with pad dust, the power generation system 100 may experience serious malfunction due to mechanical friction, electrical connection, etc. between the rotor 108 and the stator 106.

To solve the above problem, the power generation system 100 may further include a dust shield 204. The dust shield 204 is installed in a path between the brake pads 116 and the rotor 108 to shield pad dust, thereby preventing pad dust from entering the gap 203. The dust shield 204 of this embodiment includes a sleeve 205, an O-ring 206, and a seal 208. The sleeve 205 has a groove and is installed in front of the rotor 108. The sleeve 205 is directly or indirectly fixed to the stator 106, so that it does not rotate according to the rotation of the brake disc 104. The O-ring 206 and the seal 208 are installed in the groove of the sleeve 205. The seal 208 is installed in close contact with the O-ring 206. The seal 208 slides in close contact with the brake disc 104 when the brake disc 104 rotates. This configuration effectively prevents pad dust from entering the gap 203.

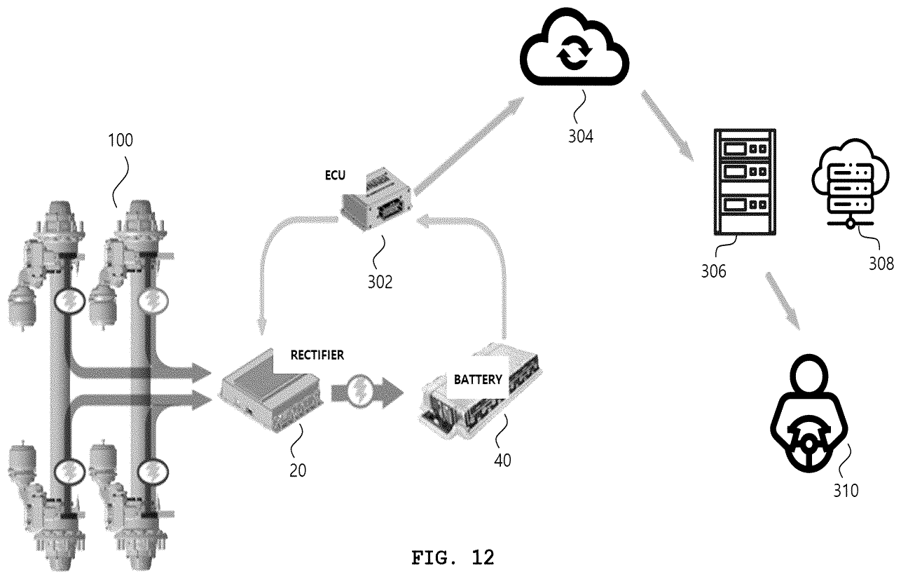

FIG. 12 is a network diagram illustrating system monitoring in an embodiment of the present invention.

The AC voltage generated in the power generation system 100 is provided to the rectifier 20. The rectifier 20 converts the AC voltage into a DC voltage and provides the DC voltage to the battery 40. The charge control unit 30 receives status information of the power generation system 100 from various sensors. This status information includes the amount of power generated by the power generation system 100, the temperature of the generator 105, a fault signal, the status of the battery 40, etc. The charge control unit 30 controls the power generation system 100, the rectifier 20, the battery 40, etc. using the received status information. In addition, the charge control unit 30 transmits the status information to an in-house computer server 304 and/or a cloud server 306 via a wireless communication network 302. Wireless communication methods include Wi-Fi, Bluetooth, LTE, 5G, etc. The in-house computer server 304 and/or the cloud server 306 generates a real-time monitoring signal using the transmitted status information and transmits it to the driver 308. The monitoring signal transmitted to the driver 308 is used through the dashboard, smartphone app, etc.

The present invention described above is not limited to the embodiments and the attached drawings, and various substitutions, modifications, and changes are possible within the scope that does not depart from the technical spirit of the present invention. This will be obvious to those skilled in the art to which the present invention belongs.

1. A power generation system for transportation, the power generation system comprising:
an axle;
a brake disc having a space in a center;
a rotor installed on an inner surface of the space to face the axle and having a plurality of permanent magnets;
a stator installed on an outer surface of the axle to face the rotor and having a coil; and
a tone wheel installed on a side of the brake disc.

2. The power generation system of claim 1, further comprising a magnetic flux controller for suppressing magnetic flux of the permanent magnets from being transmitted to the tone wheel.

3. The power generation system of claim 2, wherein the magnetic flux controller is a groove formed in the brake disc between the permanent magnets and the tone wheel.

4. The power generation system of claim 1, wherein the tone wheel is formed integrally with the brake disc.
